(19) United States
(12) Patent Application Publication
(10) Pub. No.: US 2004/0267631 A1
(43) Pub. Date: Dec. 30, 2004

(54) Match promoting system and method

(75) Inventor: Alexander Y. Narodetsky, Los Angeles, CA (US)

Correspondence Address: DUCKOR SPRADLING METZGER, 401 WEST A STREET, SUITE 2400, SAN DIEGO, CA, 92101-7915, US

(73) Assignee: Alexander Y. Narodetsky

(21) Appl. No.: 10/754,792

(22) Filed: Jan. 8, 2004

Related U.S. Application Data
(60) Provisional application No. 60/484,124, filed on Jun. 30, 2003.

(51) Int. Cl. G06F 17/60

(52) U.S. Cl. 705/26

(57) ABSTRACT

A system and method are disclosed for promoting a match between users of the system by receiving and storing user information from a first user, and then providing the user information to a second user. A request is received for a desired match from the second user, and registration is requested from at least one of the first and second users.

### FIELD OF THE INVENTION

The present invention relates in general to a match promoting system and method. It more particularly relates to such a system and method useful in facilitating the introduction of people for a variety of purposes, including, but not limited to, establishing and marketing goods and services, dating and others.

### BACKGROUND OF THE INVENTION

There is no admission that the discussion of the background of the invention legally constitutes prior art.

There have been a variety of different types and kinds of match-promoting systems and methods. For example, reference may be made to the following patents:

| Applicant | Patent Number | Patent Date |
|---|---|---|
| Walker, et al. | 5,884,272 | Mar. 16, 1999 |
| Risemberg | 5,920,845 | Jul. 6, 1999 |
| Sudai, et al. | 5,950,200 | Sep. 7, 1999 |
| Collins | 5,963,951 | Oct. 5, 1999 |
| Bezos, et al. | 6,029,141 | Feb. 22, 2000 |
| Herz | 6,029,195 | Feb. 22, 2000 |
| Collins | 6,061,681 | May 9, 2000 |
| Durand, et al. | 6,272,467 B1 | Aug. 7, 2001 |
| Cohen, et al. | 6,505,171 B1 | Jan. 7, 2003 |
| Koester | 6,594,502 B1 | Jul. 15, 2003 |
| Wang, et al. | 6,618,705 | Sep. 9, 2003 |

Conventionally, buyers and sellers of goods and services have been introduced to one another through advertising in the print media. For example, classified advertisements enabled people to buy and sell merchandise. Such advertisements have also been used to introduce people to one another for other purposes such as dating.

As a result of the proliferation of the use of public computer networks such as the Internet, goods and services have been marketed by using computers. Recently, people desiring to sell a wide variety of new and used merchandise have employed auctions and other techniques using public networks such as the Internet. This, for example, can be accomplished by auctions where the merchandise is sold to the highest bidder.

### BRIEF DESCRIPTION OF THE DRAWINGS

The following is a brief description of the drawings:

FIG. 1 is a block diagram of a match promoting system, which is constructed according to an embodiment of the invention; and

FIGS. 2 through 21 are screen shot diagrams useful in understanding the embodiment of the invention of FIG. 1.

### DETAILED DESCRIPTION OF CERTAIN EMBODIMENTS OF THE INVENTION

According to certain embodiments of the invention, there is provided a system and method of promoting a match between users of the system by receiving and storing user information from a first user, and then providing the user information to a second user. A request is received for a desired match from the second user, and registration is requested from at least one of the first and second users.

By utilizing the system and method disclosed herein, persons can be matched for the purpose of buying and selling articles such as books, collectibles or other merchandise. This system and method may also be used for a variety of other purposes such as matching persons for the purpose of dating. It is to be understood that various different types and kinds of matching is contemplated in accordance with the spirit and scope of the present invention. Also, as will become apparent to those skilled in the art, the system and method of the disclosed embodiments of the present invention may be employed by using computer networks such as the Internet, or by using other techniques such as the print media such as classified advertising.

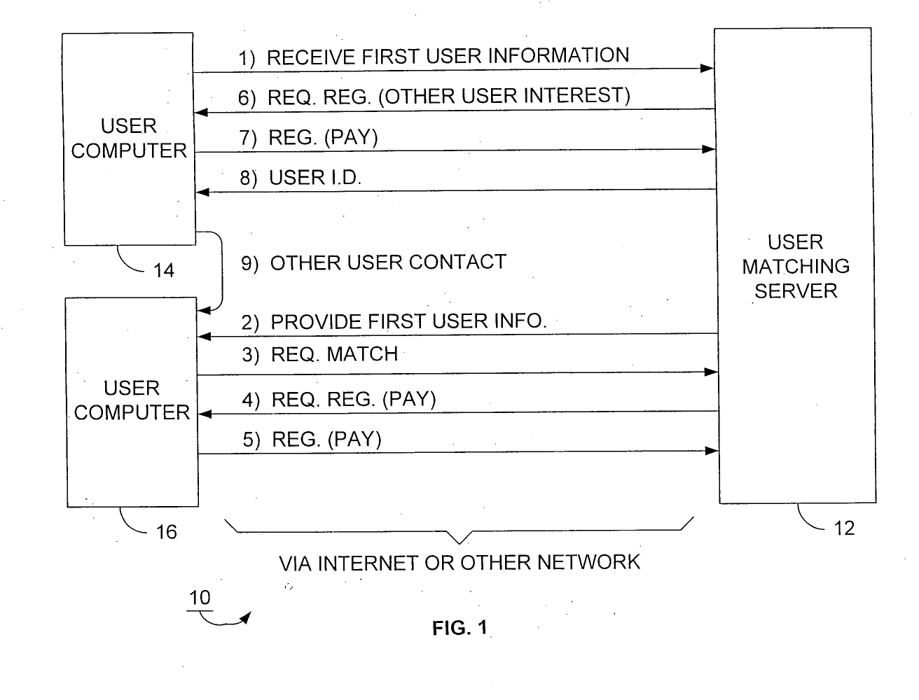

Referring now to the drawings, and more particularly to FIG. 1 thereof, there is shown a match promoting system 10, which is constructed in accordance with an embodiment of the invention. The system 10 may be employed for matching individuals desiring to sell and to buy previously used textbooks to one another. It is to be understood, however, that the system 10 is illustrative of an example of how the system and method of the present invention may be employed, and it is to be understood that other uses are contemplated as will become apparent to those skilled in the art. For example, the system 10 and the methods of using it may be used for selling and buying other types and kinds of goods and/or services, as well as for matching persons for other purposes such as for dating and other purposes. Additionally, the system 10 may be used in connection with a network such as the Internet, or with print media, telephone or other communication techniques. Therefore, the following description of the drawings is of only one embodiment of the present invention and method.

The system 10 includes a user matching server 12 which may be accessed via the Internet or other network by a group of user computers such as user computer 14 and user computer 16. In this regard, there can be a large number of user computers which are able to access the user matching server 12.

Briefly, in use, the system 10 causes the user matching server 12 to receive user information from a user computer such as the computer 14. This information is stored in the matching server 12. This information can then be provided to another user computer such as the computer 16. If this information is of interest to the user of the computer 16, a request for a match is sent from the user computer 16 to the matching server 12.

The user matching server 12 then requests registration from at least one of the computers 14 and 16. Identification information is then sent to at least one of the computers 14 and 16 in response to the registration being made. In this manner, the users of the computers 14 and 16 can then contact one another.

Considering the method in greater detail, the user computer 14 may access the user matching server 12 via the Internet or other network. The computer 14 may send user information to the user matching server 12 to store it therein. In this manner, the user information can then be displayed to other user computers such as the user computer 16.

For example, should the user computer 16 access the user matching server 12, the user computer 16 may receive information concerning a variety of users. This information can include the user information previously received and stored from the user computer 14. If the user of the computer 16 has an interest in the user information from the user computer 14, the user computer 16 sends a request signal to the user matching server 12 to request a match between the user of the computer 16 and the user who had previously sent his or her user information for storing in the server 12. It is to be understood that initially the identification of the user of storing his or her user information in the server 12 is not made available to the user computer 16 or other user computers.

Once a request for a match is received by the server 12, it sends a request for registration td the user computer 16. This message requests the user of the user computer 16 to provide information concerning the user, as well as to pay a registration fee. Once this registration is completed and the payment is made, the user of the computer 16 will then be entitled to receive contact identification information for the user computer previously posting the user information on the server 12. It is to be understood that this registration may not require payment but only require the identification of the user computer being registered. Also, it is contemplated that a request for registration signal may be sent to either one or both of the computers involved in the matching process.

Once the registration is completed for the user computer 16, a message is sent to the user computer 14 from the server 12 to request registration of the user computer 14. In this regard, this request for registration includes a message identifying the fact that another user has expressed an interest in the user information previously posted by the user computer 14.

The user computer 14 then sends a registration message including payment, if required, to the user matching server 12. In response thereto, user identification information is sent from the server 12 to the user computer 14 to provide user contact information for the user computer 16 and/or the user of the computer 16. As a result, the user of the computer 14 can then contact the user of the computer 16 to arrange for a meeting between the two users or otherwise complete a transaction between them.

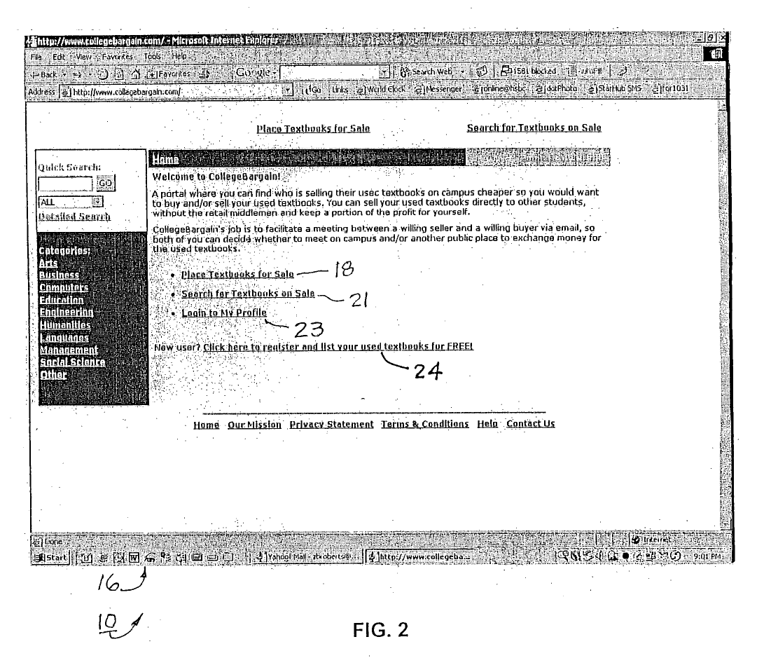

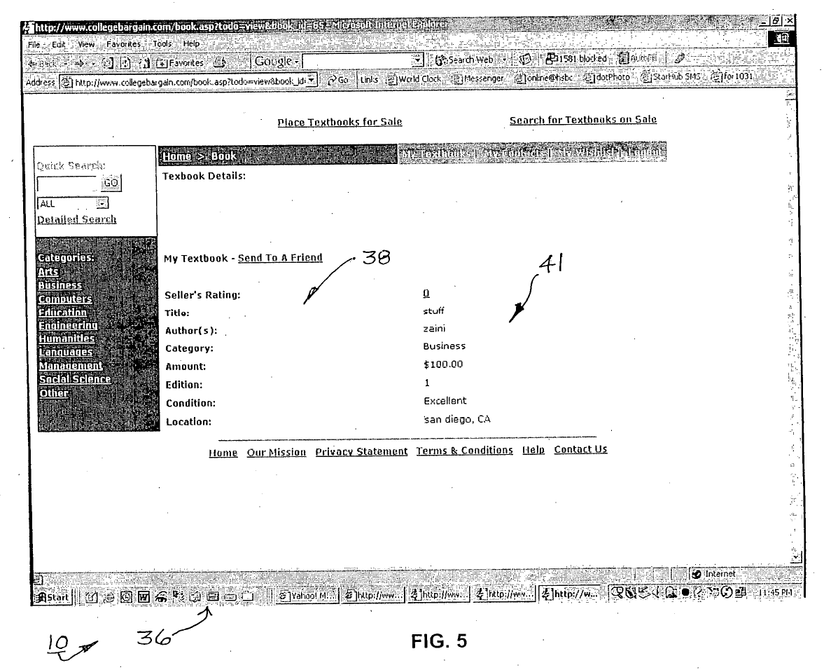

Referring now to FIGS. 2 through 18 of the drawings, a specific example of the use of the method and system 10 of FIG. 1 will now be described. The specific example relates to the purchase and sale of used textbooks via the Internet or other public network. A prospective seller may access the user matching server 12 via the user computer 14 which then is able to log in on the website of the server 12 for the system 10. As shown in FIG. 2, the user computer 14 will then receive a home page or display 16 which includes a PLACE TEXTBOOKS FOR SALE link 18. Also included is a SEARCH FOR TEXTBOOKS ON SALE link 21, as well as a LOGIN TO MY PROFILE link 23. The link 18 is used to facilitate the listing of textbooks for sale on the website. The link 21 is used by prospective buyers to view the textbooks which are posted for sale. The link 23 is used to permit a computer to login on the website so that the user can be registered. This may be a requirement prior to listing user information in the form of textbooks for sale.

A link 24 is used to permit a user to register and then list their used textbooks for free.

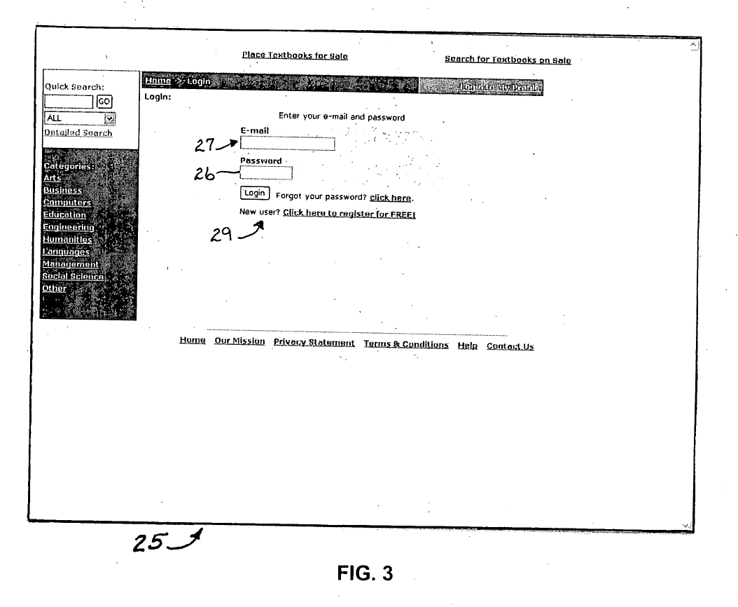

If the link 23 is selected, a login page or display 25 as shown in FIG. 3 is downloaded to the computer 14. In this regard, the user computer 14 can then enter contact information in the contact information fields 27 to provide, for example, e-mail and password information. A LOGIN button 26 may then be selected once the contact information has been entered to complete the login process. If the user is a first-time user, a CLICK HERE TO REGISTER FOR FREE link 29 is provided so that registration can then commence.

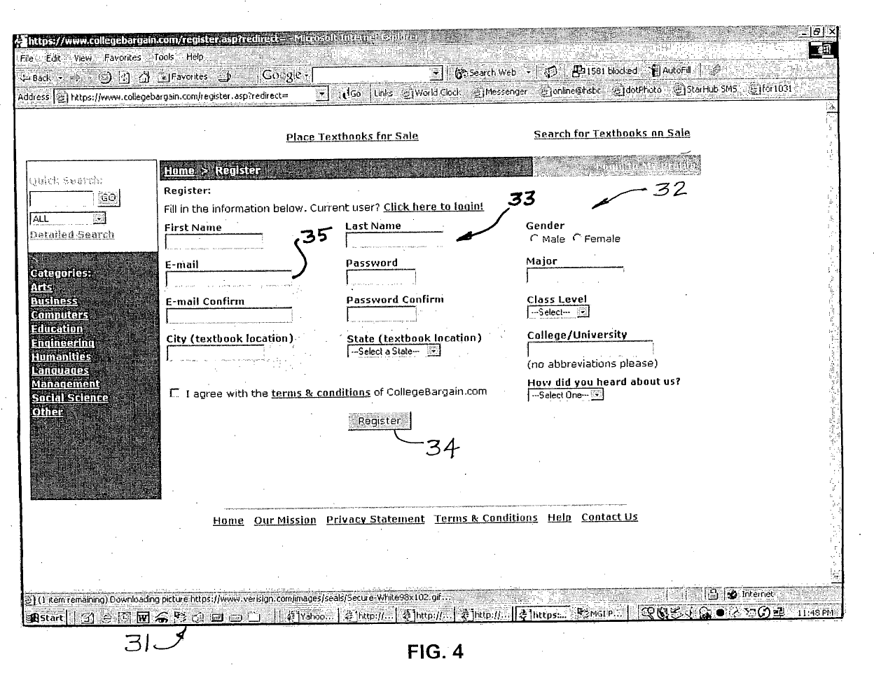

When the link 24 (FIG. 2) or the link 29 (FIG. 3) is selected, a registration page or display 31 is downloaded to the computer 14 as shown in FIG. 4. Contact information fields 32 are displayed and are made available for the user to enter the contact information into the fields for identifying the user and the user's computer. Such information includes user name fields generally indicated at 33 and a user computer e-mail 35.

Once the requested information is completed and entered in the various fields, a REGISTER button 34 is selected.

Once the registration is thus completed, a PLACE TEXTBOOKS FOR SALE page or display 36 is downloaded to the computer 14. The display 36 includes user information fields 38 to permit the user to enter his or her user information. In this regard, specific information such as the user information 41 is entered into the fields 38 to, in this example, identify a particular textbook by its title and author, as well as a category such as “BUSINESS”. User information 41 also includes a selling price for the article.

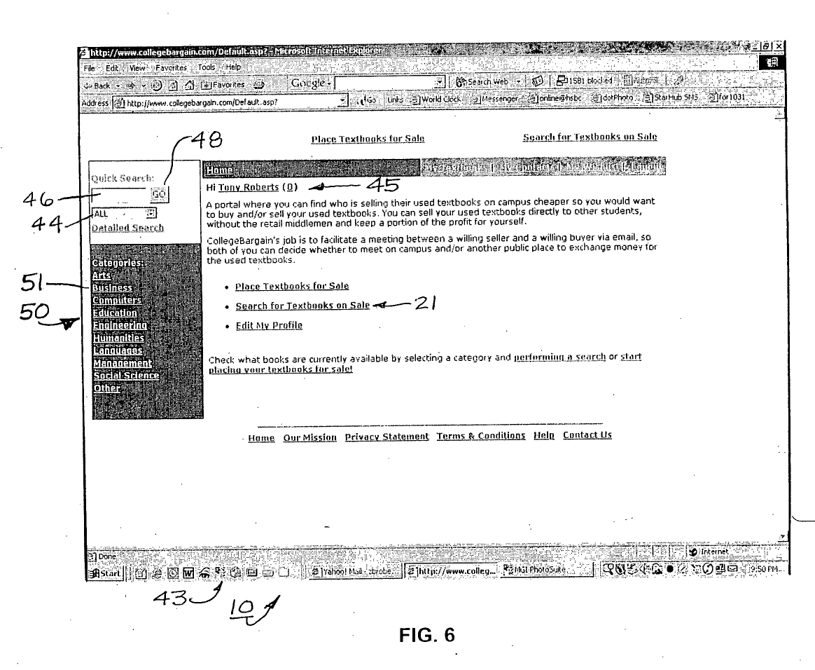

Once the user information is received by the user matching server 12 for storage therein, the server 12 can then post the user information so that it can be provided to other users. Once the textbook user information has been stored in the server 12, another user employing a computer such as the user computer 16 can access the website of the matching server 12. Once the computer such as the computer 16 logs in on the website, a home page or display 43 is downloaded to the computer 16 as shown in FIG. 6. In this regard, a registered user personal greeting 45 is displayed on the page 43. This page is similar to the page or display 16 of FIG. 2. In the present example, assuming that the user of the computer 16 intends to buy an article posted on the website of the server 12, the buyer user can enter information to perform a QUICKSEARCH by providing category information in a category field 44 which can select a variety of categories such as ALL and enter the title of a book in a QUICKSEARCH field 46.

Once this information is entered, a GO button 48 can be selected to cause a search to be conducted for that specific title amongst either all of the categories or any one specific category.

If the user is not interested in a particular title or would like to know all of the titles available for sale, a group of category information links generally indicated at 50 may be selected. For example, a BUSINESS category link 51 may be selected to display all of the books which are posted in the business category.

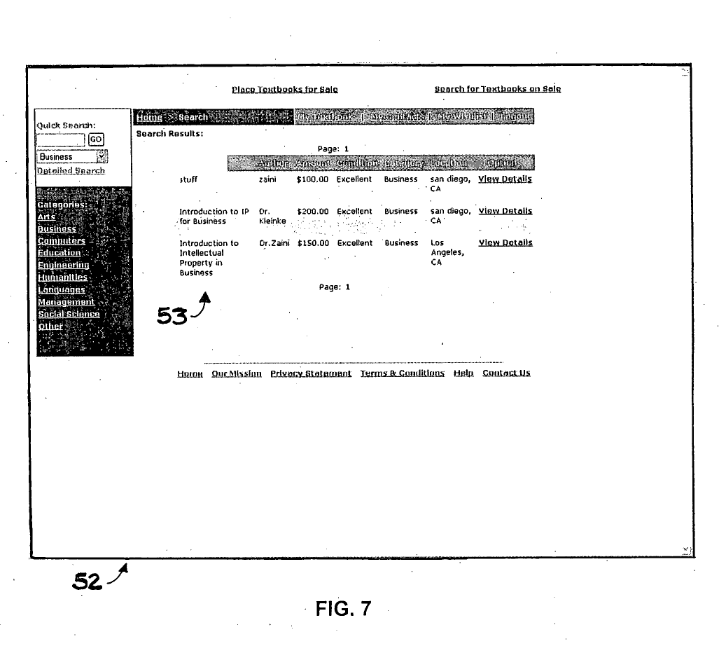

If the quick search approach is taken by completing the fields 44 and 46 and then selecting the GO button 48, a search results page or display 52 is downloaded to the computer 16 as shown in FIG. 7. The page 52 includes a user information listing 53 in the form of a list of books which have been stored in the server 12 for posting to interested users of the system 10.

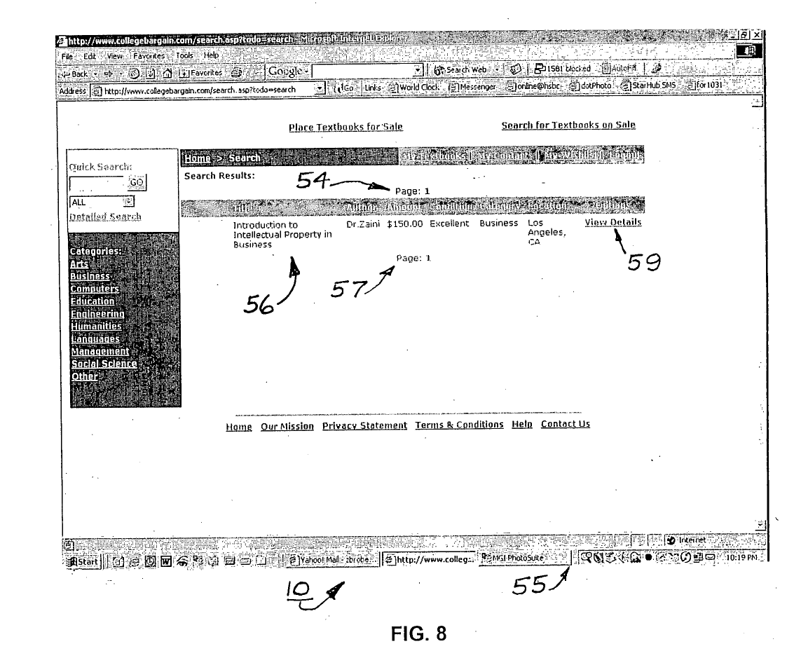

Alternatively, if one of the links 50 is selected such as the BUSINESS link 51, a search results page or display 55 is downloaded to the computer 16 as shown in FIG. 8. The page 55 includes a listing of all of the pages of stored textbook information. In the present example, there is only one page stored in the server 12 as indicated at 54. The page 55 includes the user information 56 in the present example as all of the textbooks listed in the business category. The page number as indicated at 57 is the page number of the display being viewed by the computer 16. It is to be understood that in other examples, there may be more than one page being stored, and thus the page information 54 may list more than one page of information for the selected category.

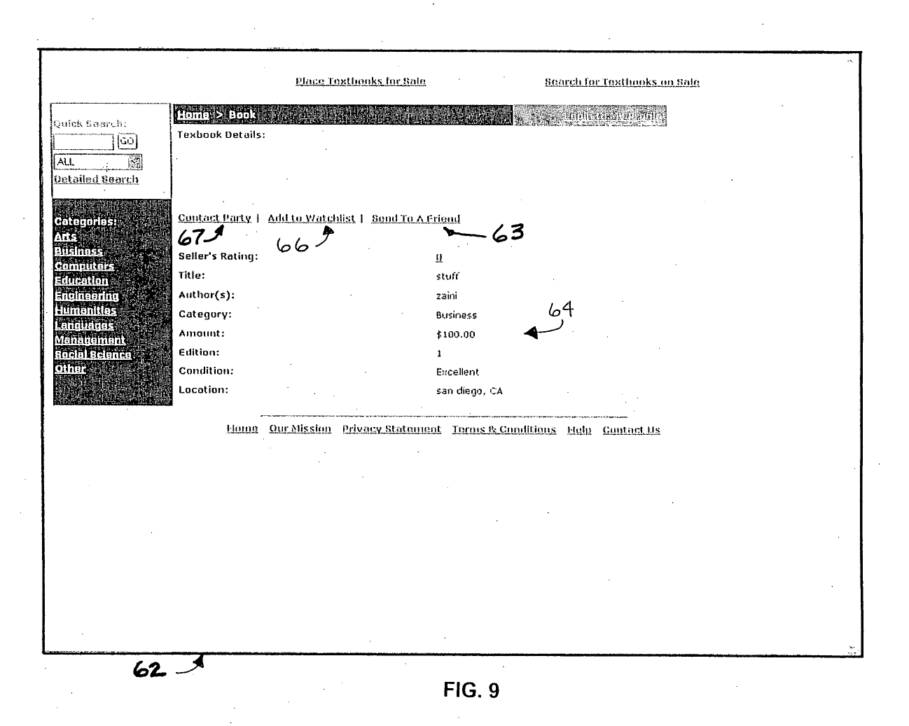

A VIEW DETAILS link 59 may be selected to obtain more information concerning the listed textbooks. When selected, a TEXTBOOK DETAILS page or display 62 is downloaded to the computer 16 as shown in FIG. 9. The page 62 includes a detailed explanation concerning the listed textbook as indicated at 64. If the user is somewhat interested in the book but not sufficiently so as to desire contacting the seller of the specific textbook in question, an ADD TO WATCHLIST link 66 may be selected to enable the buyer to track books of potential interest. A SEND TO FRIEND link 63 may also be selected to facilitate sending a copy of the textbook detail page 62 to another person who may be interested in purchasing this particular book.

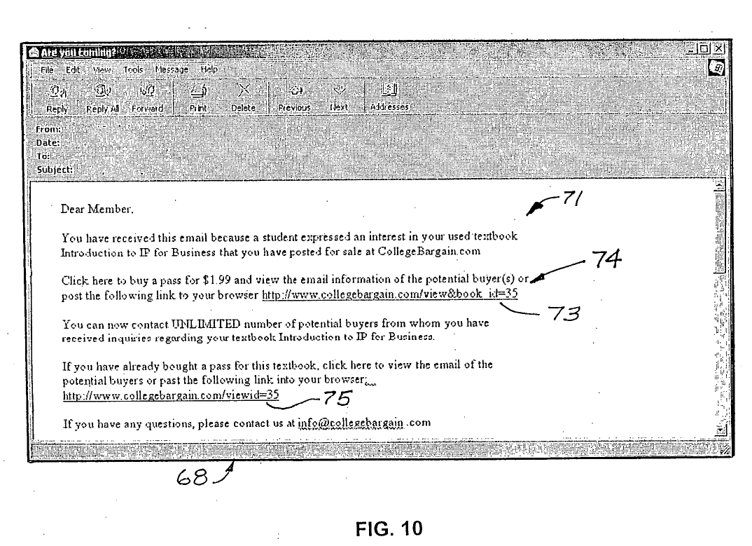

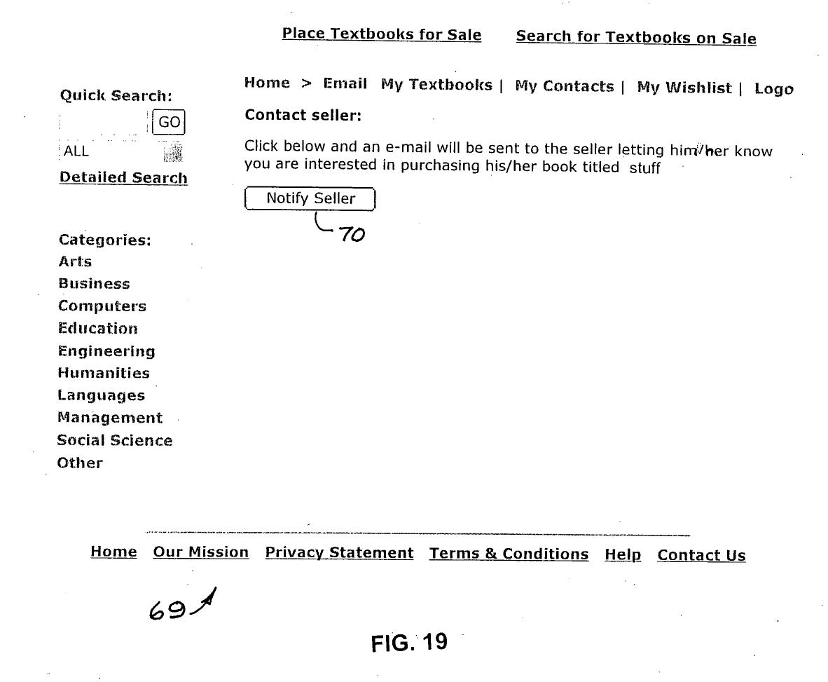

If a CONTACT PARTY link 67 is selected, the potential buyer user can contact the seller of the selected books. By selecting the link 67, a CONTACT SELLER page or display 69 is down loaded to the buyer user computer as indicated in FIG. 19 to alert the buyer that the seller may be contacted by selecting a button 70. By selecting the button 70, an email message is sent to the seller user computer 14 to alert the seller user that a potential buyer has expressed an interest in the seller's books. As hereinafter described in greater detail according to an embodiment of the invention, an indication is provided in a list of the textbooks maintained for each seller user so that the seller user may be notified of potential interest in each book offered for sale. When the NOTIFY SELLER button 70 is selected, a posted message or e-mail 68 is downloaded to the seller user computer 14 as shown in FIG. 10. The e-mail 68 in the present example includes message text 71 informing the user of the computer 14 that another user has expressed an interest in the used textbook posted for sale on the server 12. The e-mail message 68 includes a link 73 to facilitate a request 74 to have the seller user register by purchasing a pass, and thus to learn the identity of the potential buyer or buyers. In this regard, once the seller user is registered by purchasing a pass, e-mail information from the potential buyer may be viewed and thus a match between the two users can take place to possibly complete a sale transaction between the users. Once the seller user is registered, the seller user can then contact an unlimited number of potential buyers from whom inquiries have been received concerning a specific textbook offered for sale by the seller user.

A link 75 facilitates the sending of the buyer user information to the seller user, if the seller user has previously registered. In this case, a link 75 enables the registered seller user to receive the contact information concerning the potential buyer or buyers.

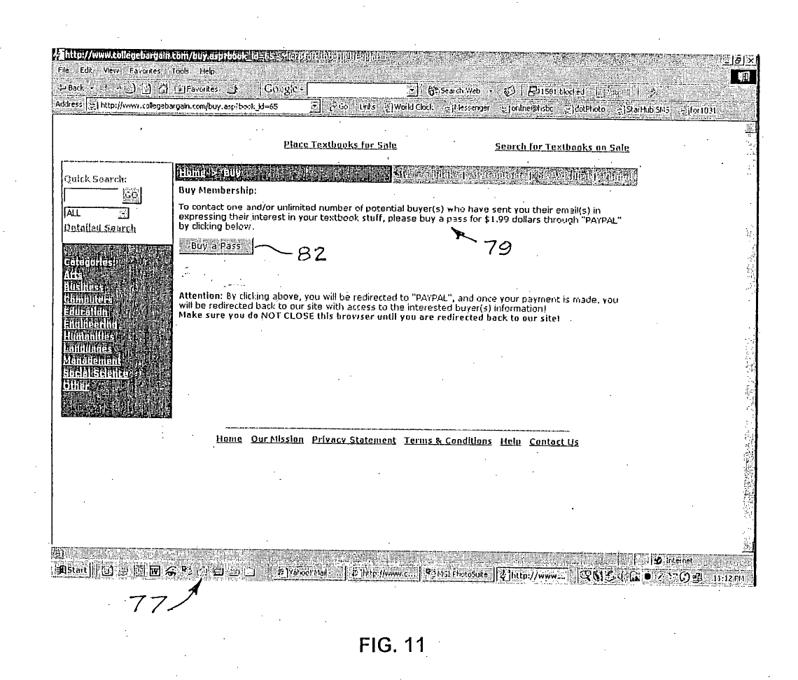

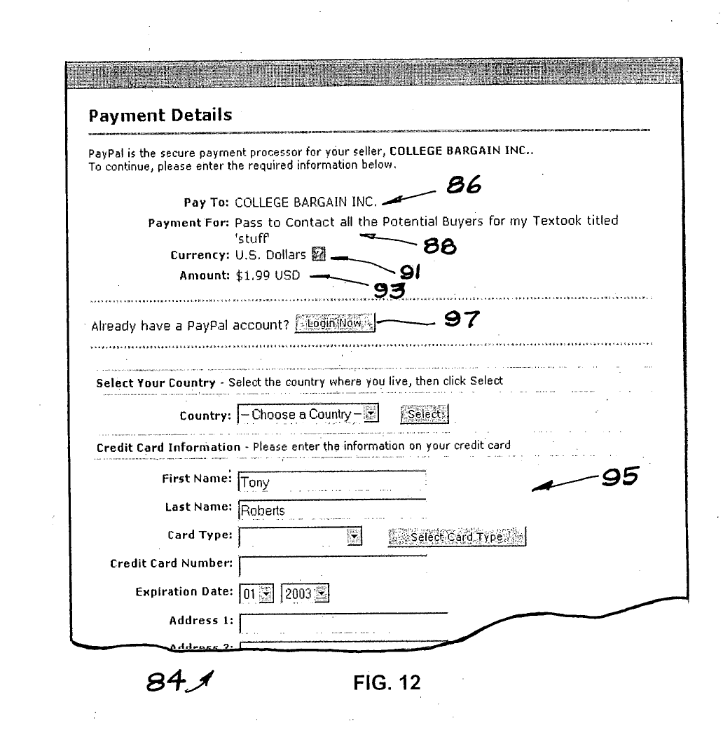

Assuming that the seller user has not previously registered, and thus selects the link 73, a BUY MEMBERSHIP page or display 77 is downloaded to the seller user computer 14 as shown in FIG. 11. The page 77 includes a message 79 the seller user is invited to register by selecting a BUY A PASS button 82. In so doing, a PAYMENT DETAILS page or display 84 is downloaded to the seller user computer 14 as shown in FIG. 12. The page 84 includes a PAY TO field indicating the company that operates the user matching server 12, and a PAYMENT FOR field 88 to identify the textbook being sold. A CURRENCY field 91 identifies the type of currency to be used in the purchase of the pass. An AMOUNT field contains the purchase price for the pass. This money is then required to be paid to a third party payment company by, for example, a credit card payment. A LOGIN NOW button 97 may be activated to cause the payment to take place, once the payment fields 95 are completed. In the present example, if the user does not have an account with the third party payment provider, the user must first register by filling out the fields 95 to submit this information to the third party for registration.

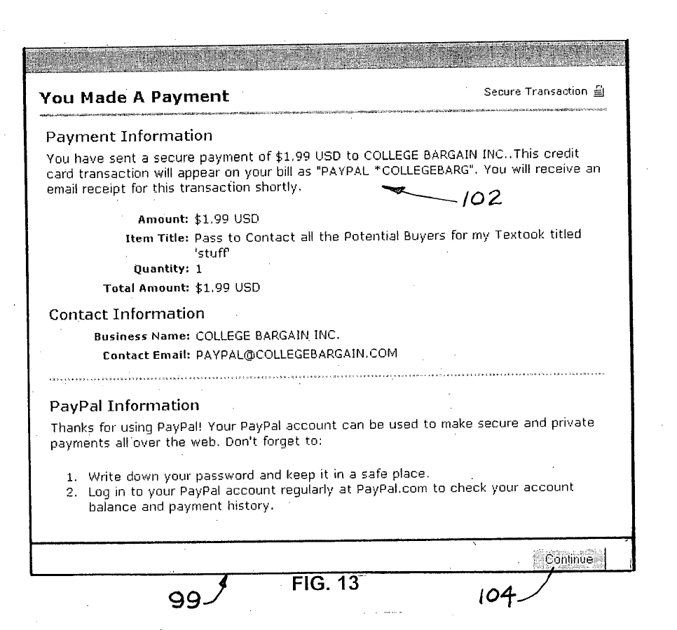

Once the payment fields in the other information are completed, in connection with the page 84, the button 97 can be selected to cause a payment verification page or display 99 (FIG. 13) to be downloaded to the computer 14. The page 99 includes a payment verification statement generally indicated at 102 to serve as confirmation to the seller user that the pass has been purchased.

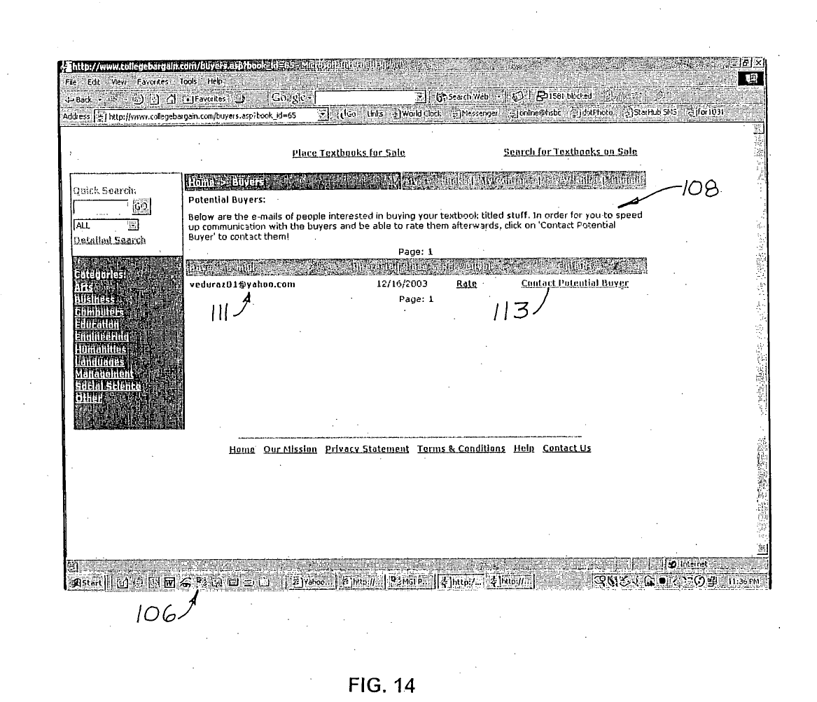

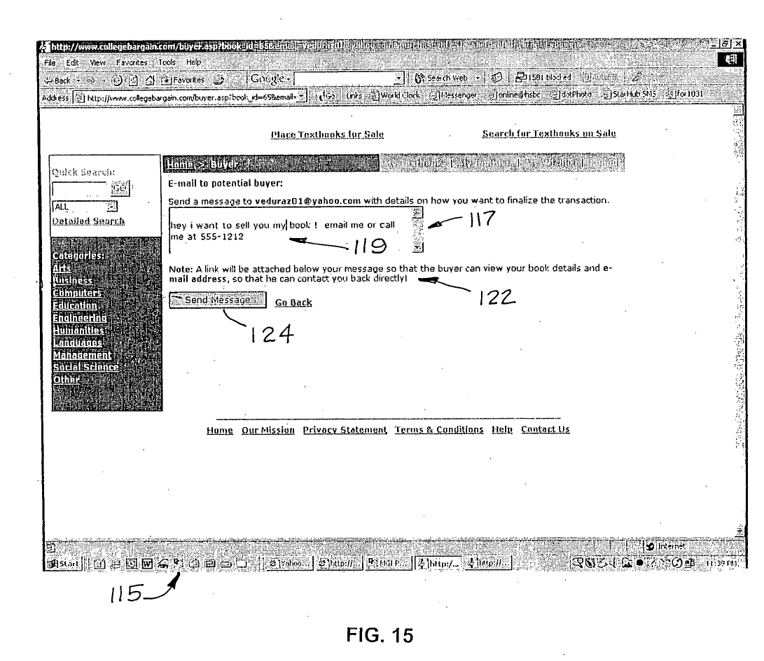

A CONTINUE button 104 can be activated by the seller user when utilizing the computer 14 to cause a message page or display 106 to be sent to the seller user computer 14 as shown in FIG. 14. The message display 106 includes a message 108 indicating that there are potential buyers interested in purchasing a specific textbook of the seller user. In order to enable the seller user and the buyer user or buyer users to communicate, a CONTACT POTENTIAL BUYER link 113 can be selected to cause an e-mail page or display 115 to be sent to the seller user as indicated in FIG. 15. The display 115 includes an e-mail field 117 so that the seller user can enter an e-mail message such as the message 119 for the potential buyer or buyers. A message 122 alerts the seller user that he or she can attach a link to the e-mail message for the buyer or buyers to provide more detailed information concerning the book in question.

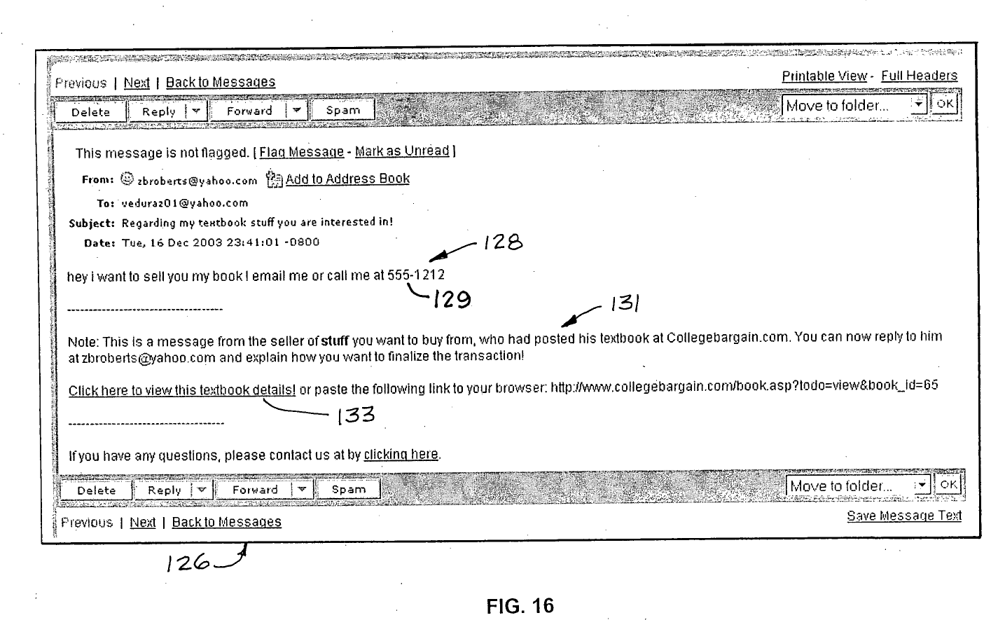

When the seller buyer selects a SEND MESSAGE button 124, an e-mail message display 126 is sent from the server 12 to the buyer user computer 16 as shown in FIG. 16. The e-mail display 126 includes an e-mail text 128 which is similar to the message 119 prepared by the seller user to provide the seller user contact information so that the potential buyer can contact the seller. In this regard, the e-mail text 128 can include certain contact information such as the telephone number of the seller user as indicated at 129. There is also a fixed message 131 explaining to the potential buyer user that this is a message from the seller user concerning a particular textbook. A link 133 enables the buyer user to receive more detailed information concerning the textbook in question.

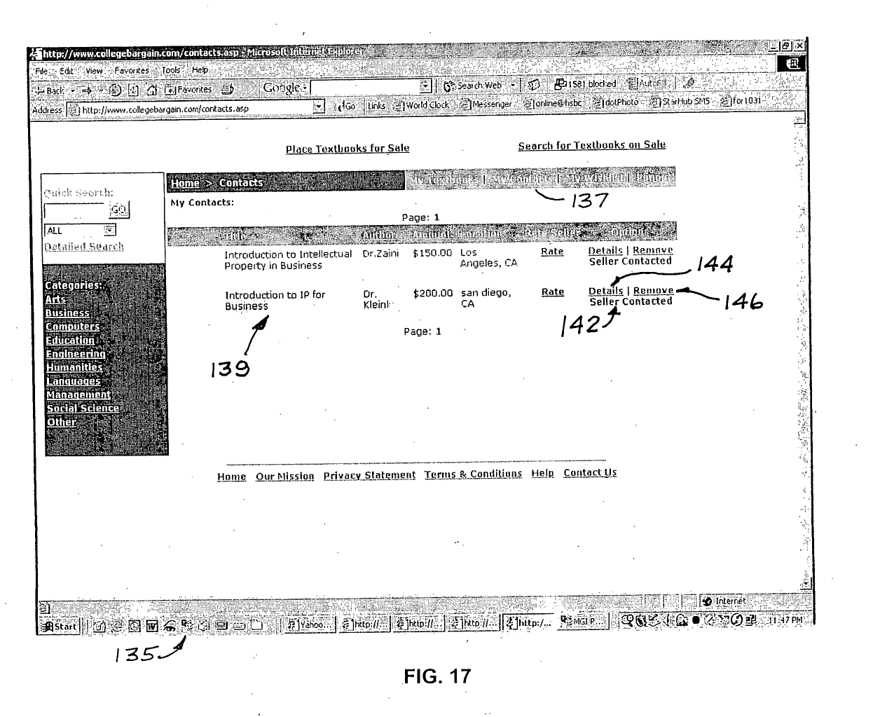

For facilitating use of the system 10 by the users, a MY CONTACTS page or display 135 can be downloaded to a user computer by the selection of a MY CONTACTS tab 137 as shown in FIG. 17. The page 135 includes the user information in the form of a list of books which are of interest to a particular buyer user. If the buyer user has contacted a seller concerning the particular book on the list, a SELLER CONTACTED information 142 appears adjacent to the title of the book in the listing 139. Also, adjacent to each listing is a DETAILS link 144 is provided to enable the buyer user to immediately receive more information concerning the particular book in question. If the buyer user is no longer interested in this particular book, a REMOVE link 146 is required to delete that entry from the page 135.

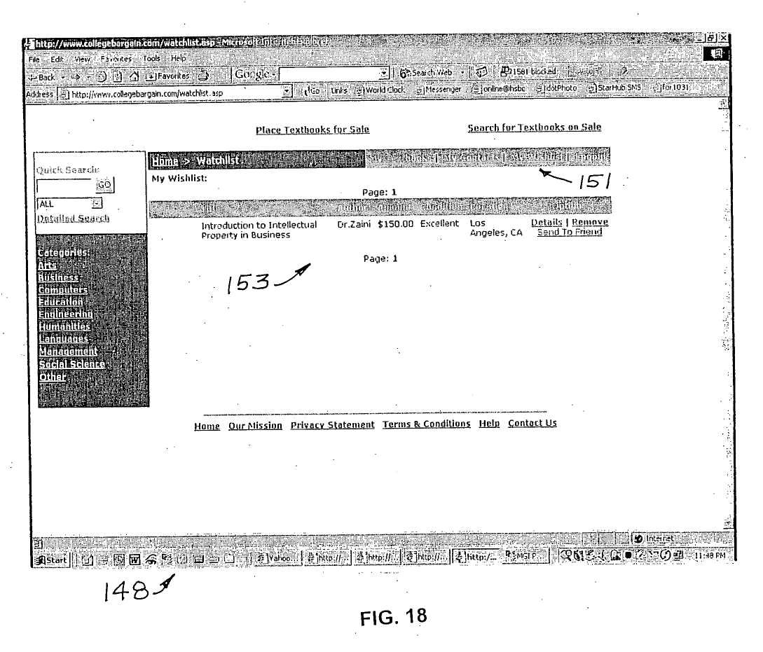

Similarly, a MY WATCHLIST page or display 148 can be downloaded to a user computer by activating a MY WATCHLIST button or tab 151 as shown in FIG. 18. The page 148 includes a listing of articles in the form of textbooks as indicated at 153. This page 148 thus provides information to the user as to which textbooks have been placed on the wishlist for this particular potential buyer user.

The system of the disclosed embodiment is in the form of an Internet enabled system for buying and selling goods and services such as used books.

Considering now a more detailed overview of the method of the disclosed embodiment of the invention, as shown in FIG. 2, at the “Home Page” 16 a visitor can determine what used textbooks are available by selecting a DETAILED SEARCH link to retrieve a page or display (not shown) to be filled out by the user to search for a specific book. Alternatively, a “Quick Search,” (i.e., author's name, book title, ISBN number or other information) may be used by filing in the fields 44 and 46 (FIG. 6). The search is initiated by selecting the GO button 48.

If a prospective purchaser finds the textbook he or she is looking for, as indicated in FIG. 9, the person can click on ADD TO WATCHLIST link 66 to add the book to a wishlist or watchlist, or click on CONTACT THE SELLER link 67 in the TEXTBOOK DETAILS screen 62 describing the book's condition, location and price at 64. If the visitor likes what he or she sees, he or she clicks on the link 67, to contact the seller.

An e-mail will be automatically sent to a seller, informing him or her of the potential buyer's interest. If the potential buyer is not registered with the company providing the matching service, he or she may be prompted to do so before he or she can send an e-mail.

Once the e-mail is received and read by the seller, he or she must click on the link in the body of the e-mail to be directed to the third party payment provider such as the payment provider operating under the trade name Paypal, and pay $1.99 or other consideration, if desired, in order to be able to contact the potential buyer and to receive his/her e-mail. By completing the registration, and paying this fee if required, the seller would be entitled to contact, at his/her discretion, an unlimited number of potential buyers who have sent him or her e-mails expressing an interest in the same textbook.

After the payment is complete, the seller may view the e-mail(s) of potential buyers. A seller may send an e-mail to potential buyers to arrange for them to meet at a public place or elsewhere so that the buyer can examine the book and pay the seller for the book. This will complete the transaction.

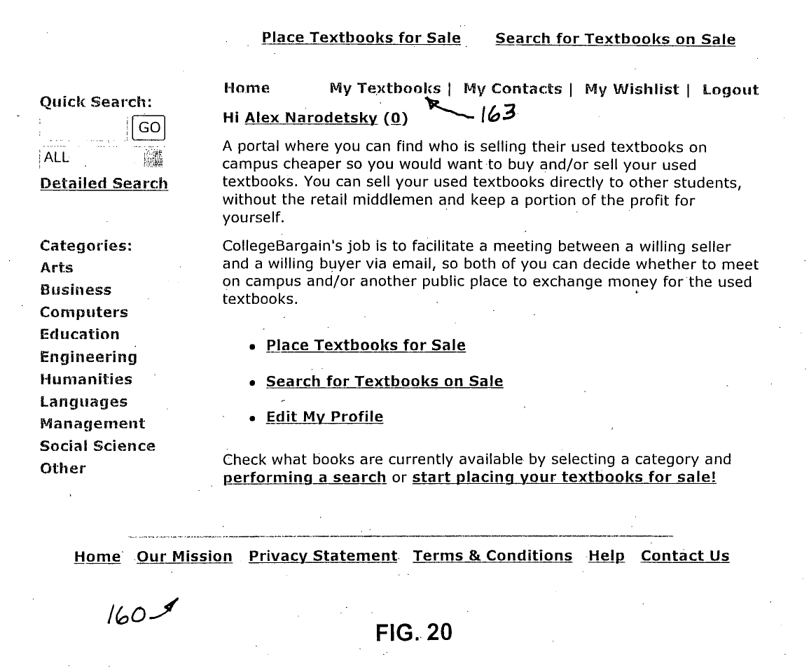

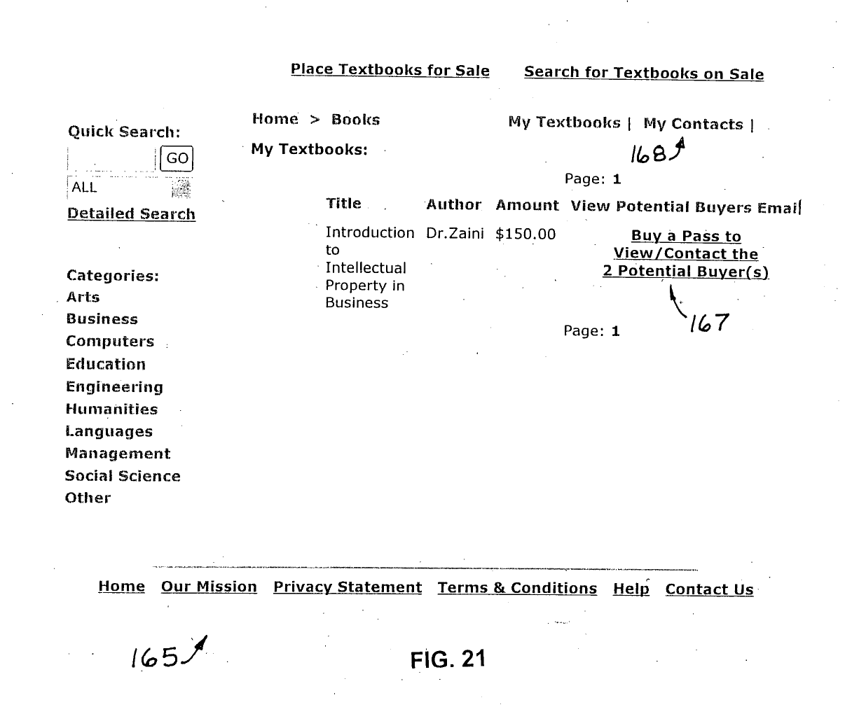

By logging in as a member, a seller user may view the “Home Page” such as a page 160 illustrated in FIG. 20, and may view or edit the textbooks in a “MyTextbooks” link 163, where he or she can change a price or add, delete or change information about the books listed. As shown in FIG. 22, by selecting the link 163, a page 165 is downloaded to the seller user computer to provide a list of all of the books offered for sale by this seller user. By selecting a BUY A PASS TO VIEW/CONTACT THE 2 POTENTILA BUYER(S) link 167, the seller will be invited to register as shown in FIG. 11, before receiving the contact identity information of the one or more potential buyers.

By logging in as a member, a buyer user may view the “Home Page”, and may access a MY CONTACT link 168 (FIG. 22) and see the names of those he or she has contacted as shown in FIG. 17. After a time interval such as 48 hours, a person may rate the level of satisfaction they experienced in dealing with the other person (i.e., positive, negative, or neutral). These ratings may be visible online, and a user who accumulates numerous negative ratings decreases the likelihood that future users will elect to contact him or her. In addition, users with numerous negative ratings may be barred from using the system 10. In order to establish an atmosphere of professionalism, customers are encouraged to acknowledge each other's e-mails and, if a book is sold, to inform other potential buyers. At the “My Wishlist” link, the user lists books that a prospective buyer may have an interest in, giving him or her time to compare prices before deciding which buyer or seller to contact.

To be able to place books on the system 10, the user may be required to register with the system 10, but there may or may not be a cost for such registration.

Although particular and specific embodiments of the invention have been disclosed in some detail, numerous modifications will occur to those having skill in the art, which modifications hold true to the spirit of this invention. Such modifications are deemed to be within the scope of the following claims.

What is claimed is:

1. A method of providing a match between users, comprising:
receiving and storing user information from a first user;
providing the user information to a second user;
receiving a request for a desired match from the second user;
requesting registration from at least one of the first and second users; and sending identification information to at least one of the first and second users in response to the registration being made.

2. A method according to claim 1, wherein the requesting of registration includes requesting payment from the second user.

3. A method according to claim 1, wherein the requesting registration includes requesting payment from the first user.

4. A method according to claim 1, wherein the user information includes article identification information.

5. A method according to claim 1, wherein the identification information includes personal contact identification information.

6. A method according to claim 5, further including receiving information via a network.

7. A method according to claim 1, further including in response to the receiving a request includes sending a message to the first user that one or more other users have desired a match, and providing a message for such interest in a list for the first user.

8. A system of providing a match between users, comprising:
means for receiving and storing user information from a first user;
means for providing the user information to a second user;
means for receiving a request for a desired match from the second user;
means for requesting registration from at least one of the first and second users; and
means for sending identification information to at least one of the first and second users in response to the registration being made.

9. A system according to claim 8, wherein the means for requesting registration includes requesting payment from the second user.

10. A system according to claim 8, wherein the means for requesting registration includes means for requesting payment from the first user.

11. A system according to claim 8, wherein the user information includes article identification information.

12. A system according to claim 8, wherein the identification information includes personal contact identification information.

13. A system according to claim 12, further including means for receiving information via a network.

14. A system according to claim 8, further including means responsive to receiving a request includes means for sending a message to the first user that one or more other users have desired a match, and for providing a message of such interest in a list for the first user.
